(19) United States
(12) Patent Application Publication
(10) Pub. No.: US 2026/0349287 A1
(43) Pub. Date: Nov. 5, 2026

(54) OPTICAL DEVICE WITH PHASE-CHANGE MATERIALS AND METHOD OF FABRICATING THE SAME

(71) Applicant: TAIWAN SEMICONDUCTOR MANUFACTURING COMPANY LTD., HSINCHU (TW)

(72) Inventors: KUO-PIN CHANG, HSINCHU COUNTY (TW); KUO-CHING HUANG, HSINCHU CITY (TW); HUNG-JU LI, HSINCHU CITY (TW); YU-WEI TING, TAIPEI CITY (TW)

(21) Appl. No.: 19/738,605

(22) Filed: Jul. 13, 2026

Related U.S. Application Data
(62) Division of application No. 18/476,342, filed on Sep. 28, 2023.

(51) Int. Cl. G02F 1/01

(52) U.S. Cl. CPC G02F 1/0147

(57) ABSTRACT

One embodiment of the present disclosure provides an optical device which includes a waveguide and a light modulator. The light modulator includes a phase-change material and is in direct contact with an outer surface of the waveguide. The optical device also includes a thermal conducting member. The thermal conducting member is positioned on the light modulating member. The optical device further includes a heating member. The heating member is placed on the thermal conducting member and is distant away from the light modulator and the waveguide. The heat produced from the heating member is transferred to the light modulator through the thermal conducting member thereby inducing a phase transition of the light modulator.

### PRIORITY CLAIM AND CROSS-REFERENCE

This application is a divisional application of U.S. application Ser. No. 18/476,342 filed on Sep. 28, 2023. The contents of the above-referenced Patent Application are hereby incorporated by reference in their entirety.

### BACKGROUND

The growth of the internet and network traffic rate is pushing a demand for optical-based data communication. Optical signals are usable for high speed and secure data transmission between two devices. Many of optical devices used in the optical-based data communication systems may be fabricated in semiconductor devices, and may be further integrated as a silicon photonic integrated chips (PIC) for high-speed optical interconnects. Optical modulation is a process of modifying light waves according to high-frequency electrical signals that contain information so as to realize the transmission of data and information through optical communication channels like optical fiber or waveguides in the form of light signals.

Although existing tool for optical modulation have been generally adequate for their intended purposes, they have not been entirely satisfactory in all respects. Consequently, there is a need to improve the efficiency and reliability of optical modulation for data and information transmission.

### BRIEF DESCRIPTION OF THE DRAWINGS

Aspects of the embodiments of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 is a schematic view of an optical device, in accordance with one or more embodiments of the present disclosure.

FIGS. 2A-2E illustrate various stages in an optical device fabrication process, in accordance with one or more embodiments of the present disclosure.

FIG. 3A is a schematic view of a heating member, in accordance with one or more embodiments of the present disclosure.

FIG. 3B is a diagram illustrating a temperature distribution on the heating member of FIG. 3A during its operation.

FIG. 4A is a schematic view of a heating member, in accordance with one or more embodiments of the present disclosure.

FIG. 4B is a diagram illustrating a temperature distribution on the heating member of FIG. 4A during its operation.

FIG. 5 illustrates pulse power scheme and transient thermal dynamics for changing the structural phase of a phase-change material.

FIG. 6 is a transmission versus wavelength graphs of one phase-change material in different structural phases.

FIG. 7A is a schematic view of an optical device, in accordance with one or more embodiments of the present disclosure.

FIG. 7B is a schematic view of a light controlling unit, in accordance with one or more embodiments of the present disclosure.

FIG. 8 is a top view of partial elements of an optical device, in accordance with one or more embodiments of the present disclosure.

FIGS. 9A-9E illustrate various stages in an optical device fabrication process, in accordance with one or more embodiments of the present disclosure.

FIG. 10 is a schematic view of an optical device, in accordance with one or more embodiments of the present disclosure.

FIG. 11 is a top view of partial elements of an optical device, in accordance with one or more embodiments of the present disclosure.

FIG. 12 is a top view of partial elements of an optical device, in accordance with one or more embodiments of the present disclosure, where light modulators in lines L11, L12, and L13 and light modulators in lines L21, L22, and L23 are set in different structural phases.

FIG. 13 is a top view of partial elements of an optical device, in accordance with one or more embodiments of the present disclosure, where light modulators in lines L11, L12, and L13 and light modulators in lines L21, L22, and L23 are set in different structural phases.

FIG. 14 is a top view of partial elements of an optical device, in accordance with one or more embodiments of the present disclosure.

FIG. 15 is a block diagram of a computing system, in accordance with one or more embodiments of the present disclosure.

FIG. 16 is a schematic view of a photon controller, in accordance with one or more embodiments of the present disclosure.

FIG. 17 is a schematic view of partial elements of a photon controller, in accordance with one or more embodiments of the present disclosure.

FIG. 18 is a schematic view of a computing system, in accordance with one or more embodiments of the present disclosure.

FIG. 19 is a flowchart illustrating a method of fabricating an optical device, in accordance with one or more embodiments of the present disclosure.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first,” “second” and “third” describe various elements, components, regions, layers and/or sections, these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation.

Optical modulation allows one to control an optical wave or to encode information on a waveguides. Controlling the travel and propagation of light in the waveguides involves manipulating the flow of light through the waveguide structure, whereby data can be stored, processed, and retrieved in the photonic device. Embodiments of the present disclosure provide an optical device including phase-change materials (PCM). By indirectly applying thermal energy to the phase-change materials, the structural phase thereof is adjusted so as to manipulate the characteristics of light, such as frequency or intensity, traveling in a waveguide. Compared with directly applying heat to the phase-change materials, indirect heating mechanisms advantageously improve the reliability of the phase-change materials, which consequentially provides an extended fatigue life of the optical device and ensures stable operation.

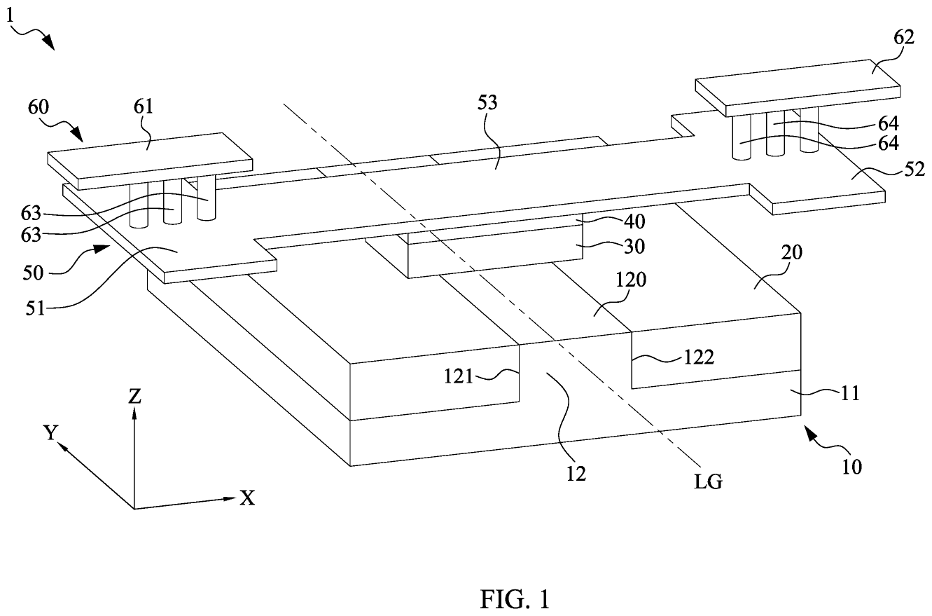

FIG. 1 is a schematic view of an optical device 1, in accordance with one or more embodiments of the present disclosure. In accordance with some embodiments, the optical device 1 includes a waveguide 10, a cladding layer 20, a light modulator 30, a thermal conducting member 40, a heating member 50, and an electrical connecting unit 60. It would be appreciated that some structure of the optical device, such as the element for supporting the heating member 50 and the electrical connecting unit 60, are not illustrated for clarity of discussion. Furthermore, the features described below can be replaced or eliminated in other embodiments of the optical device 1.

The waveguide 10 is a structure used for guiding the flow of electromagnetic wave in a direction parallel to its axis, confining it to a region either within or adjacent to its surfaces. In the embodiment shown in FIG. 1, the waveguide 10 is a silicon photonic rib waveguide and includes a base portion 11 and a rib portion 12. The base portion 11 may be formed on an insulation layer (not shown in the figures), which is made with silicon oxide and is formed on a silicon substrate (not shown in the figures). The rib portion 12 is formed on the base portion 11 and has a top surface 120 defined at a side of the rib portion 12 that is farthest away from the base portion 11.

The dimensions of the rib portion 12 and the base portion 11 may be determined according to the application of the optical device 1. For example, in case where the rib portion 12 has a larger cross-sectional area relative to the base portion 11 may produce advantages such as low coupling loss between an optical fiber and the waveguide, but light with multiple polarization states can be passed through. In some exemplary embodiments, in cases where the width of the rib portion 12 is below about 800 nm, silicon photonic rib waveguide will be single mode for each polarization. However, it will be appreciated that many variations and modifications can be made to embodiments of the disclosure. Waveguide with different geometries may be used in the optical device of the present disclosure. For example, the waveguide may be a non-planar waveguide and have a circular or rectangular cross-section.

The cladding layer 20 is configured to reduce the optical loss of light propagating through the waveguide 10. In some embodiments, the material of the cladding layer has a lower refractive index than the waveguide 10—in other words, light travels slower through the waveguide 10 than through the cladding layer 20. The wave in the cladding layer 20 decays very rapidly for evanescent waves. In one exemplary embodiment, the waveguide 10 is made of pure silica or silicon nitride (Si₃N₄) with a high refractive index and the cladding layer 20 is made of silica-based material, such as silicon oxide (SiO₂), which has lower refractive index. It would be appreciated that the upper portion of the cladding layer 20 which covers the top surface 120 of the rib portion 12 of the waveguide 10 is not illustrated in FIG. 1. In addition, while not illustrated in FIG. 1, there may be another cladding layer positioned underneath the waveguide 10.

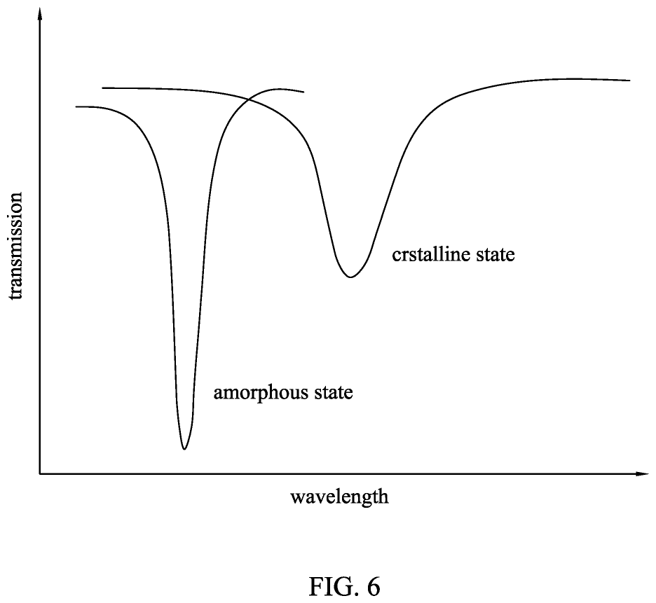

The light modulator 30 is configured to regulate the light beam propagating through the waveguide 10. In some embodiments, the light modulator 30 includes a layer of phase-change material (PCM) and is directly formed on an outer surface of the waveguide 10, such as top surface 120 of the rib portion 12 of the waveguide 10. In some embodiments, the light modulator 30 is in direct contact with the top surface 120 of the waveguide 10, there is absence other material between the bottom surface of the light modulator 30 and the top surface 120 of the waveguide 10. The phase-change material can be rapidly and reversibly switched between an amorphous state and a crystalline state, wherein the optical and electronic properties of the amorphous state and the crystalline state differ tremendously. The ability to switch rapidly between two states with different properties qualifies these materials for applications in optical modulation. For example, FIG. 6 illustrates how a phase-change material on top of a waveguide can be programmed to the amorphous state and the crystalline state and subsequently read out as a change in transmission of the waveguide relative to light with different wavelengths. The transmission is defined as the ratio between output and input optical intensity. The phase-change material may include Ge₂Sb₂Te₅ (GST), Ge₂Sb₂Se₄Te₁ (GSST), Sb₂S₃, or Sb₂Se₃, or the like.

The thermal conducting member 40 is positioned between the light modulator 30 and the heating member 50, and is configured to transfer heat from the hotter one to the colder one of the light modulator 30 and the heating member 50. For example, when the heating member 50 is applied with electrical pulses, heat is transferred from the heating member 50 to the light modulator 30 through the thermal conducting member 40. After the application of the electrical pulse to the heating member 50 is stopped, the temperature of the heating member 50 will be dissipated quickly, and thus heat is transferred from the light modulator 30 to the heating member 50 through the thermal conducting member 40. The thermal conducting member 40 may have high thermal conductivity and is electrical insulators, to prevent electrical current from being transferred to the light modulator 30 so as to improve the reliability of the light modulator 30. In one exemplary embodiment, the light modulator 30 includes silicon nitride, aluminum nitride, diamond, sapphire, or the like.

In some embodiments, as shown in FIG. 1, the light modulator 30 extends across the top surface 120 of the waveguide 10 (i.e., the bottom surface of the light modulator 30 passes through the two side walls 121 and 122 of the rib portion 12 and partially covers the cladding layer 20), and the thermal conducting member 40 has the same area as the light modulator 30. Through such an arrangement, light passing through the region covered by the light modulator 30 will be sufficiently modulated by the light modulator 30. However, it will be appreciated that many variations and modifications can be made to embodiments of the disclosure. In some other embodiments, the light modulator 30 does not extend across the top surface 120 of the waveguide 10. The width of the light modulator 30 in a traversal direction (X-axis direction) is less than the width of the top surface 120 of the waveguide 10 in the same direction.

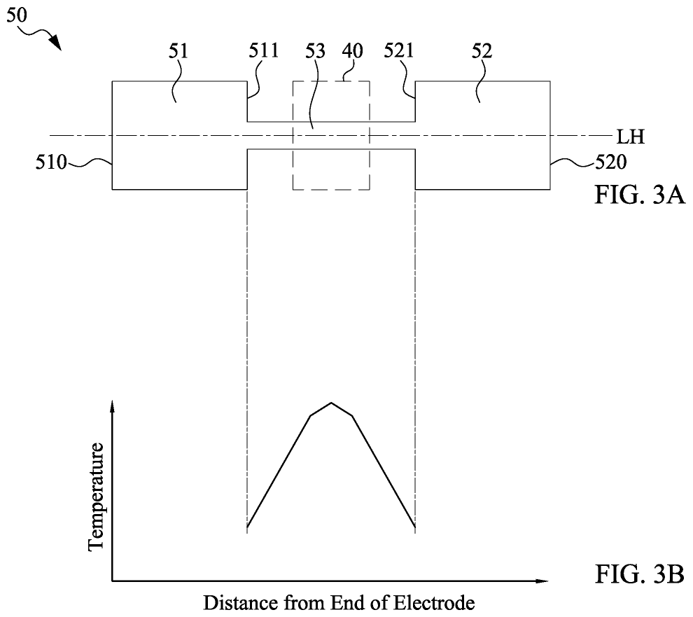

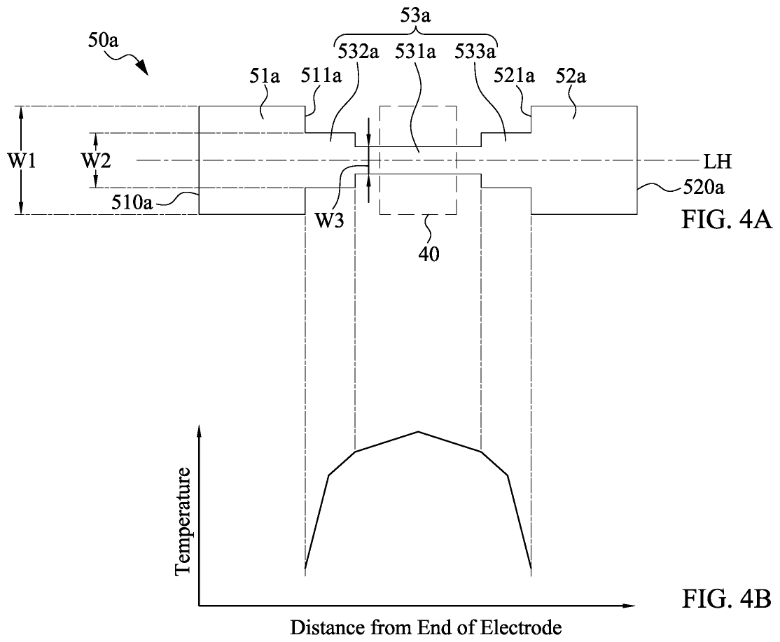

The heating member 50 is configured to produce heat in response to the application of electrical pulses provided by the electrical connecting unit 60. The configuration of the heating member 50 will be described in details in the embodiments related to FIG. 3A and FIG. 4A. The electrical connecting unit 60 includes a first metal pad 61, a second metal pad 62, and multiple contacts 63 and 64. A first set of one or more contacts 63 extends downward from the first metal pad 61 to an electric contact segment 51 of the heating member 50 (e.g., to the cathode of the heating member 50) to couple the first metal pad 61 to the heating member 50. A second set of one or more contacts 64 extends downward from the second metal pad 62 to an electric contact segment 52 of the heating member 50 (e.g., to the anode of the heating member 50) to couple the second metal pad 62 to the heating member 50. It would be appreciated that the number and the arrangement of the metal pads and the contacts of the electrical connecting unit 60 should not be limited to the embodiments shown in FIG. 1 and can be varied according to different demands. For example, the contacts 63 and/or the contacts 64 may be arranged on the heating member 50 along a line that is parallel to the longitudinal direction (Y-axis direction) of the waveguide 10.

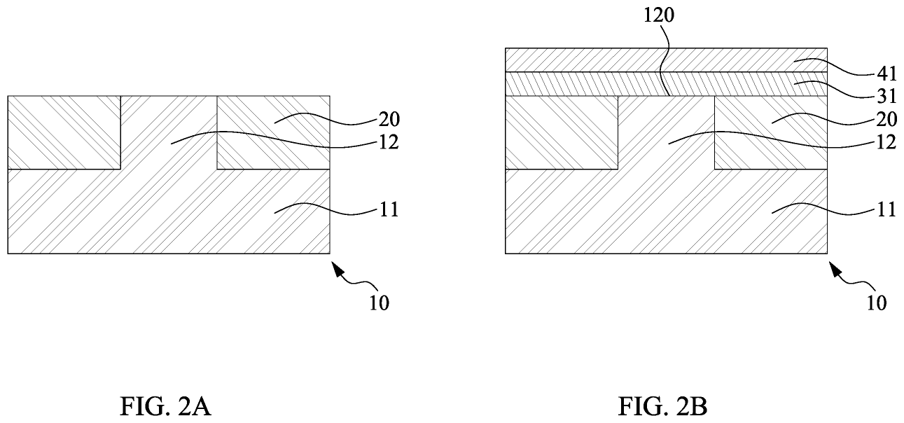

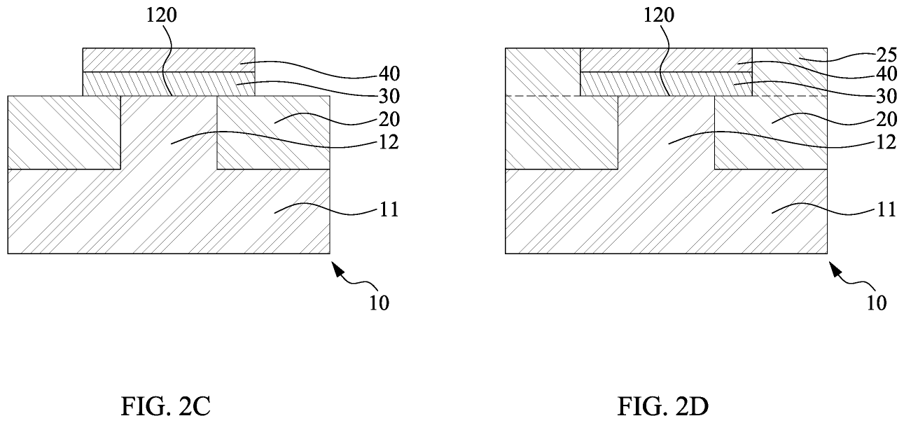

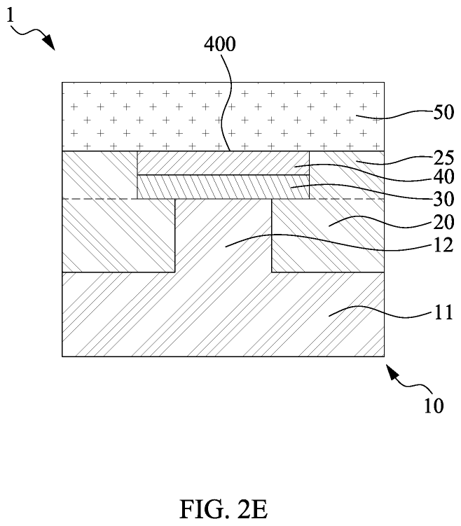

FIGS. 2A-2E illustrate various stages in an optical device fabrication process, in accordance with one or more embodiments of the present disclosure. While methods are described as a series of acts, it will be appreciated that the order of the acts (and/or portions of those acts) may be altered in other embodiments. Further still, while FIGS. 2A-2E illustrate a specific series of acts, some acts that are illustrated and/or described may be omitted in other embodiments. Further, additional acts that are not illustrated and/or described in FIGS. 2A-2E may be included in other embodiments.

In some embodiments, as shown in FIG. 2A, the method of fabricating the optical device 1 includes forming the waveguide 10 and the cladding layer 20. The cladding layer 20 may be formed on the waveguide 10 through deposition. The deposition may, for example, be performed by atomic layer deposition (ALD), vapor deposition, or some other suitable deposition process. In some embodiments, the cladding layer 20 is a silica-based material, such as silicon oxide (SiO₂). Optionally, a chemical mechanical planarization (CMP) operation is carried out to planarize an upper surface of the cladding layer 20 with the top surface 120 of the waveguide 10.

After the formation of the cladding layer 20, as shown in FIG. 2B, the method of fabricating the optical device 1 also includes forming (e.g., depositing) a layer of phase-change material 31 on the top surface 120 of the waveguide 10 and forming a layer of thermal conducting material 41 on the layer of phase-change material 31. The deposition may, for example, be performed by atomic layer deposition (ALD), vapor deposition, or some other suitable deposition process.

After the formation of the layer of phase-change material 31 and the layer of thermal conducting material 41, as shown in FIG. 2C, the method of fabricating the optical device 1 also includes patterning the layer of phase-change material 31 and the layer of thermal conducting material 41 by a photolithography/etching process so as to form the light modulator 30 and the thermal conducting member 40. In some embodiments, since the light modulator 30 and the thermal conducting member 40 are patterned by the same process, the side walls of the light modulator 30 flush with the side walls of the thermal conducting member 40.

After the formation of the light modulator 30 and the thermal conducting member 40, as shown in FIG. 2D, the method of fabricating the optical device 1 also includes forming another cladding layer 25 on the top surface 120 of the waveguide 10. The cladding layer 25 transversally surrounds the light modulator 30 and the thermal conducting member 40 and covers the top surface 120 of the waveguide 10 that is exposed by the light modulator 30. Optionally, a CMP operation is carried out to planarize an upper surface of the cladding layer 25 with the upper surface of the thermal conducting member 40. The cladding layer 25 and the cladding layer 20 may be made from the same material.

After the formation of the cladding layer 25, as shown in FIG. 2E, the method of fabricating the optical device 1 also includes forming the heating member 50 on a top surface of the thermal conducting member 40. The heating member 50 has a high thermal conductivity, e.g., between about 100 watts per meter-kelvin (W/(m−k)) and about 400 W/(m−k), such that the heating member 50 functions as a heat sink for the thermal conducting member 40. The heating member 50 is a copper foil, in the illustrated embodiment, although other metal foil comprising a suitable material, such as gold, tungsten, aluminum, silver the like, or combinations thereof, may also be used. A thickness of the metal foil is between about 10 μm and about 50 μm, such as 30 μm, although other dimensions are also possible. The heating member 50 may be formed (e.g., deposited) by physical vapor deposition (PVD), chemical vapor deposition (CVD), or the like. In some embodiments, the heating member 50 extends in a plane that is parallel to the top surface 120 of the waveguide 10 and is distant away from light modulator 30. That is the heating member 50 and the light modulator 30 are located at different levels, the heat transmitted between the heating member 50 and the light modulator 30 is transferred in a Z-axis direction that is perpendicular to the top surface of the waveguide 10.

In some embodiments, as shown in FIG. 3A, the heating member 50 includes two electric contact segments 51 and 52 and an intermediate segment 53. The two electric contact segments 51 and 52 are positioned at two ends 510 and 520 of the heating member 50 and arranged a longitudinal axis LH. The intermediate segment 53 connects the two electric contact segments 51 and 52 and being in contact with the thermal conducting member 40. In some embodiments, in a traverse direction that is perpendicular to the longitudinal axis LH of the heating member 50, a width of the intermediate segment 53 is less than a width of the two electric contact segments 51 and 52, such that the intermediate segment 53 has a higher current density than that of the two electric contact segments 51 and 52 when electrical pulse is applied to the heating member 50. The higher current density represents higher temperature. As a result, as shown in FIG. 3B, the heating member 50 has the highest temperature in the central region (i.e., region where the thermal conducting member 40 is connected) and gradually decreases in temperature towards the ends (i.e., two electric contact segments 51 and 52.)

FIG. 4A is a schematic view of a heating member 50a, in accordance with one or more embodiments of the present disclosure. In one alternative embodiments, the heating member 50a includes two electric contact segments 51a and 52a and an intermediate segment 53a. The two electric contact segments 51a and 52a are positioned at two ends 510a and 520a of the heating member 50 and arranged along a longitudinal axis LH. The intermediate segment 53a connects the two electric contact segments 51a and 52a and being in contact with the thermal conducting member 40. In some embodiments, a width of the intermediate segment 53a varies in a traverse direction that is perpendicular to the longitudinal axis LH. Specifically, as shown in FIG. 4A, the intermediate segment 53a includes a middle contacting portion 531a and two intermediate portions 532a and 533a. The middle contacting portion 531a is in contact with the thermal conducting member 40, and the two intermediate portions 532a and 533a each connects one end of the middle contacting portion 531a to the electric contact segments 51a and 52a. A width W2 of the two intermediate portions 532a and 533a is greater than a width W3 of the middle contacting portion 531a in the traverse direction. In addition, a width W1 of the electric contact segments 51a and 52a is greater than the width W2 of the two intermediate portions 532a and 533a.

Referring to FIGS. 3A and 4A, the inner ends 511a and 521a of the electric contact segments 51a and 52a are positioned farther away from the thermal conducting member 40 compared to the inner ends 511 and 521 of the electric contact segments 51 and 52, which represents the electric contact segments 51 and 52 has a larger area than the electric contact segments 51a and 52a. Therefore, the heat dissipation rate at the two end regions of the intermediate segment 53 is higher than that of the end regions of the intermediate segment 53a. Consequently, the temperature on the intermediate segment 53a is distributed more uniformly compared to the intermediate segment 53. The uniform temperature distribution on the intermediate segment 53a allows the thermal conducting member 40 to be evenly heated, achieving a temperature at which a structural phase transition of the light modulator 30 can occur, even when less power is applied to the heating member 50a.

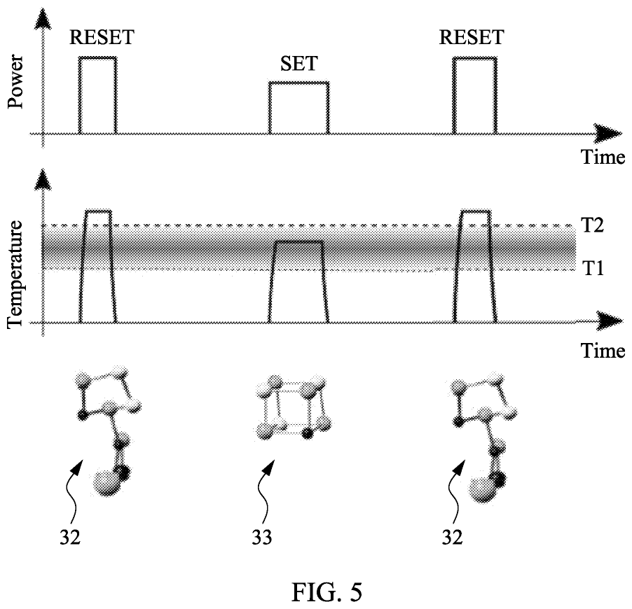

FIG. 5 illustrates pulse power scheme and transient thermal dynamics for changing the structural phase of a phase-change material. Thanks to he nature of the phase-change material of the light modulator 30 exhibits different optical transmission in the different structural phases, optical transmission of the phase-change material decreases from 95% in the case of aGST (GST in amorphous state) to 26% with cGST (GST in crystallized state.) In the present disclosure, to switch the structural state of the phase-change material, electrical pulse is applied to the heating member 50 or 50a (FIGS. 3A and 4A) and thus generates heat. The heat from the heating member 50 or 50a is transferred to the light modulator 30 through the thermal conducting member 40 thereby inducing a phase transition of the light modulator 30.

Generally, as shown in FIG. 5, a short and high-amplitude electrical pulse is used to melt-quench (i.e., temperature sharply rising above the melting temperature (T2) and quickly dissipates to room temperature) the phase-change material to an amorphous state 32. In contrast, a longer and lower amplitude electrical pulse is used to anneal the PCM with temperature ramping up between melting temperature (T2) and transition temperature (T1) for a certain period (to recrystallize the atomic lattice), before finally ramping the temperature down to room temperature. With the annealing process, the phase-change material is changed to a crystalline state 33. For application in photonic memory, the amorphous state is also referred to as a “RESET” state, and the crystalline state is also referred to as a “SET” state, in some embodiments. The “RESET” state corresponds to digital data “1” stored in a memory cell, and the “SET” state corresponds to digital data “0” stored in the memory cell. According to Experimental results, transition temperature T1 is about 620 K to about 660 K with pulse time duration from 1 μs down to 100 ns and T2 is about 900 K for GST.

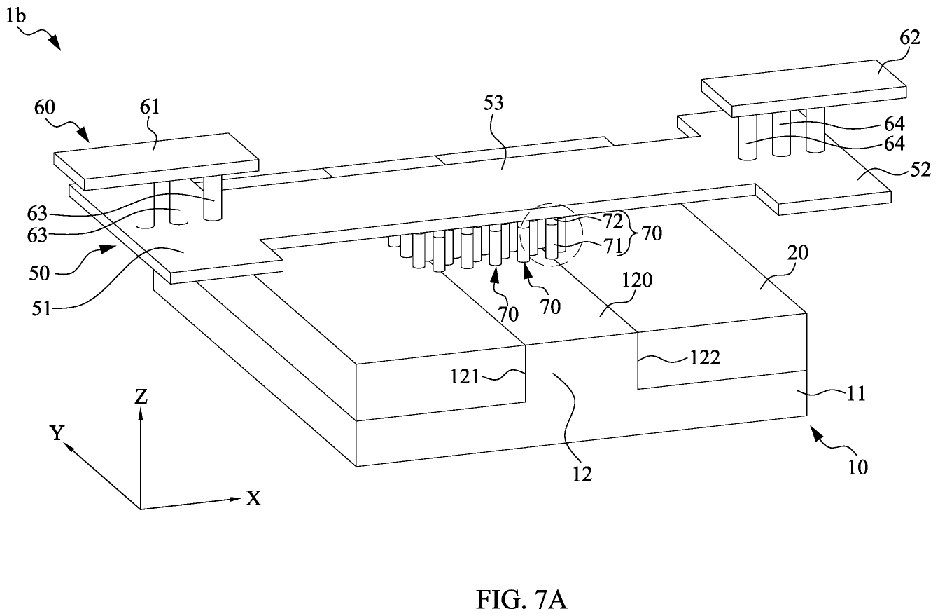

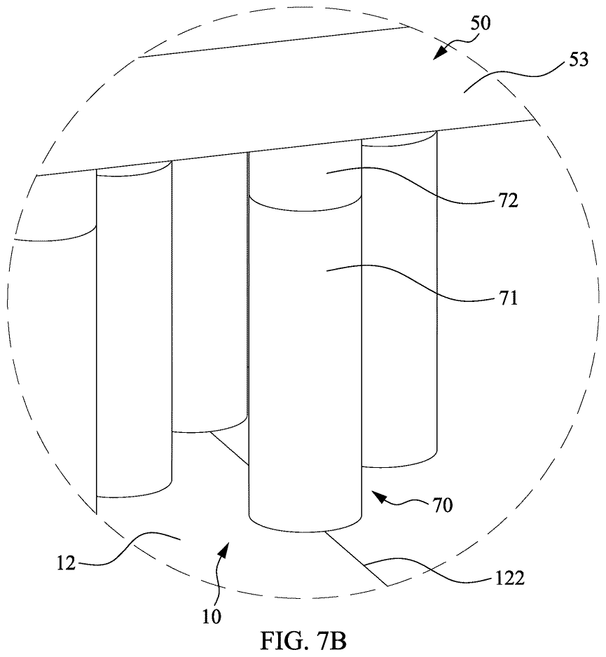

FIG. 7A is a schematic view of an optical device 1b, in accordance with one or more embodiments of the present disclosure. The components in FIG. 7A that use the same reference numerals as the components of FIG. 1 refer to the same components or equivalent components thereof. For the sake of brevity, it will not be repeated here. Differences between the optical device 1b and the optical device 1 include the light modulator 30 and the thermal conducting member 40 being replaced with a plurality of light modulators 71 and a number of thermal conducting members 72.

As shown in FIG. 7B, the thermal conducting member 72 is formed atop of the light modulator 71. The light modulator 71 and the thermal conducting member 72 cooperatively constitute one light controlling unit 70. Referring back to FIG. 7A, the light controlling units 70 are arranged in an array and positioned on the top surface 120 of the rib portion 12 of the waveguide 10 or the top surface of the cladding layer 20. Specifically, the light modulator 71 of each light controlling unit 70 is in direct contact with the top surface 120 of the rib portion 12 of the waveguide 10 or the top surface of the cladding layer 20. The thermal conducting members 72 of each of the light controlling unit 70 is in direct contact with the bottom surface of the intermediate segment 53 of the heating member 50. With such an arrangement, heat produced from the heating member 50 is transferred to the light modulators 71 through the thermal conducting members 72 thereby inducing a phase transition of the light modulators 71. The light modulators 71 and the thermal conducting members 72 may be made of the same material as the light modulator 30 and the thermal conducting member 40, respectively.

In some embodiments, as shown in FIG. 7B, each of the light modulators 71 is a cylinder with a circular cross section, and the thermal conducting member 72 atop the light modulators 71 is a cylinder with a circular cross section as well. However, it will be appreciated that many variations and modifications can be made to embodiments of the disclosure. The light modulators 71 and the thermal conducting member 72 may have different cross sections. For example, each of the light modulators 71 and the thermal conducting member 72 is a cylinder with a square or a hexagonal cross section.

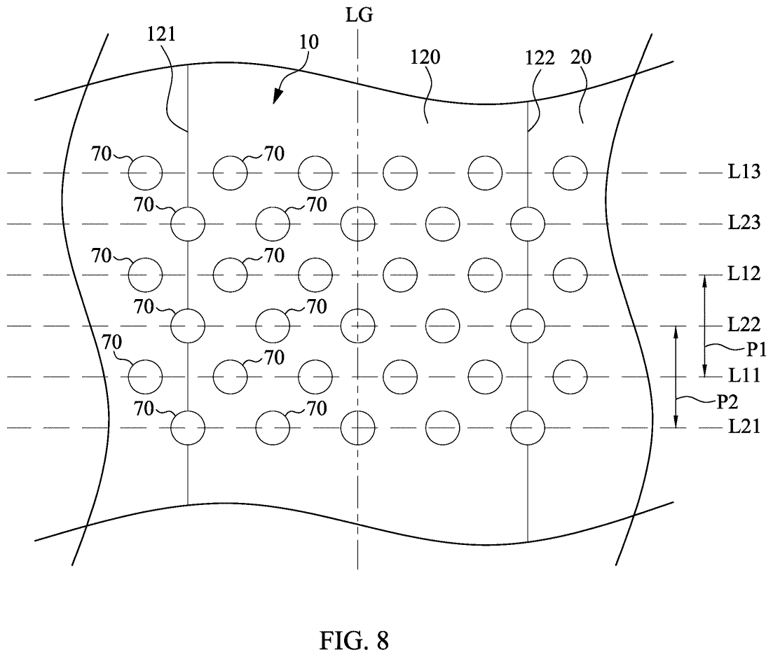

Referring to FIG. 8, a number of first reference lines L11, L12 and L13 and a number of second reference lines L21, L22, and L23 are defined on a plane at which the top surface 120 of the waveguide 10 locates and each extends perpendicular to a longitudinal axis LG of the waveguide 10. The first reference lines L11, L12 and L13 are spaced apart from each other by a first pitch P1. The second reference lines are spaced apart from each other by a second pitch P2. In the embodiment shown in FIG. 8, the first pitch P1 is identical with the second pitch P2.

A first group of the light controlling units 70 are arranged along the first reference lines L11, L12 and L13, and a second group of the light controlling units 70 are arranged along the second reference lines L21, L22, and L23. Therefore, the light controlling units 70 in a direction parallel to the longitudinal axis LG of the waveguide 10 are periodically arranged. In this way, the electromagnetic wave propagating in the waveguide will change its propagating mode due to resonance. The pitches P1 and P2 may be designed so that light at particular frequency may be resonated in the light modulators 71 of the light controlling units 70. In some embodiments, the light controlling units 70 arranged along the first reference lines L11, L12 and L13 are staggered with light controlling units 70 arranged along second reference lines L21, L22, and L23. By such an arrangement, the number of elements per unit area can be increased, thereby improving the precision of light control.

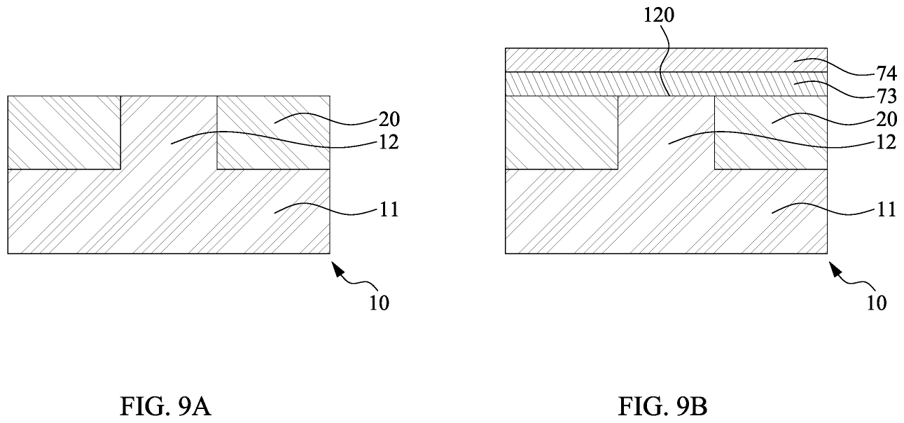

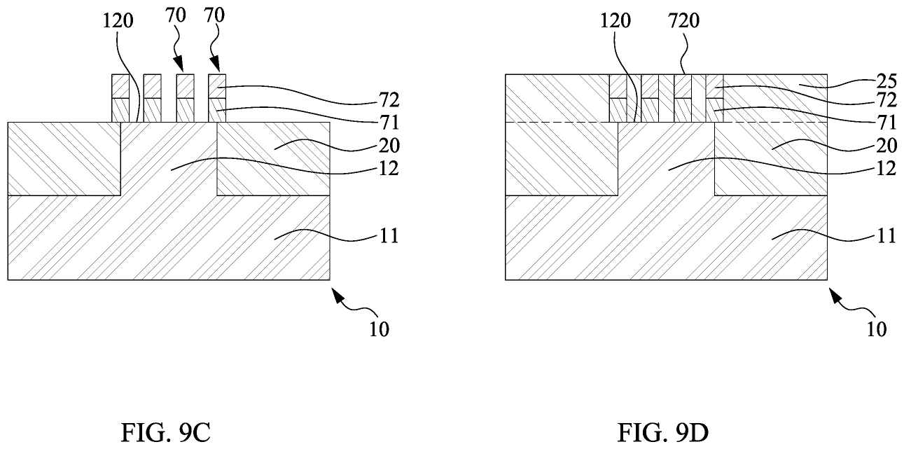

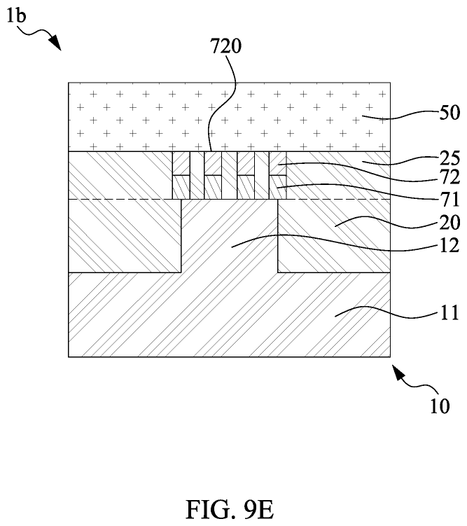

FIGS. 9A-9E illustrate various stages in an optical device fabrication process, in accordance with one or more embodiments of the present disclosure. While methods are described as a series of acts, it will be appreciated that the order of the acts (and/or portions of those acts) may be altered in other embodiments. Further still, while FIGS. 9A-9E illustrate a specific series of acts, some acts that are illustrated and/or described may be omitted in other embodiments. Further, additional acts that are not illustrated and/or described in FIGS. 9A-9E may be included in other embodiments.

In some embodiments, as shown in FIG. 9A, the method of fabricating the optical device 1b includes forming the waveguide 10 and the cladding layer 20. The cladding layer 20 may be formed on the waveguide 10 through deposition. The deposition may, for example, be performed by atomic layer deposition (ALD), vapor deposition, or some other suitable deposition process. In some embodiments, the cladding layer 20 is a silica-based material, such as silicon oxide (SiO₂). Optionally, a chemical mechanical planarization (CMP) operation is carried out to planarize an upper surface of the cladding layer 20 with the top surface 120 of the waveguide 10.

After the formation of the cladding layer 20, as shown in FIG. 9B, the method of fabricating the optical device 1b also includes forming (e.g., depositing) a layer of phase-change material 31 on the top surface 120 of the waveguide 10 and forming a layer of thermal conducting material 74 on the layer of phase-change material 73. The deposition may, for example, be performed by atomic layer deposition (ALD), vapor deposition, or some other suitable deposition process.

After the formation of the layer of phase-change material 73 and the layer of thermal conducting material 74, as shown in FIG. 9C, the method of fabricating the optical device 1b also includes patterning the layer of phase-change material 73 and the layer of thermal conducting material 74 by a photolithography/etching process so as to form the light controlling units 70. In some embodiments, since the light modulator 71 and the thermal conducting member 72 are patterned by the same process, the side wall of the light modulator 71 flushes with the side wall of the thermal conducting member 72.

After the formation of the light modulator 71 and the thermal conducting member 72, as shown in FIG. 9D, the method of fabricating the optical device 1b also includes forming another cladding layer 25 on the top surface 120 of the waveguide 10. The cladding layer 25 transversally surrounds the light modulator 71 and the thermal conducting member 72 and covers the top surface 120 of the waveguide 10 that is exposed by the light controlling units 70. Optionally, a CMP operation is carried out to planarize an upper surface of the cladding layer 25 with the upper surface 720 of the thermal conducting member 72. The cladding layer 25 and the cladding layer 20 may be made from the same material.

After the formation of the cladding layer 25, as shown in FIG. 9E, the method of fabricating the optical device 1b also includes forming the heating member 50 on a top surface of the thermal conducting member 72. The heating member 50 has a high thermal conductivity, e.g., between about 100 watts per meter-kelvin (W/(m−k)) and about 720 W/(m−k), such that the heating member 50 functions as a heat sink for the thermal conducting member 72. The heating member 50 is a copper foil, in the illustrated embodiment, although other metal foil comprising a suitable material, such as gold, tungsten, aluminum, silver the like, or combinations thereof, may also be used. A thickness of the metal foil is between about 10 μm and about 50 μm, such as 71 μm, although other dimensions are also possible. The heating member 50 may be formed (e.g., deposited) by physical vapor deposition (PVD), chemical vapor deposition (CVD), or the like. In some other embodiments, the heating member 50 is replaced with the heating member 50a shown in FIG. 4A. The heating member 50a can be formed by the same or similar process.

In operation, electrical pulses are applied to the heating member 50 or the heating member 50a, and the heat produced by the heating member 50 or the heating member 50a is transferred to the light modulators 71 through the thermal conducting members 72. As a result, the structural phase of the light modulators 71 is changed according to the control method depicted in FIG. 5 above.

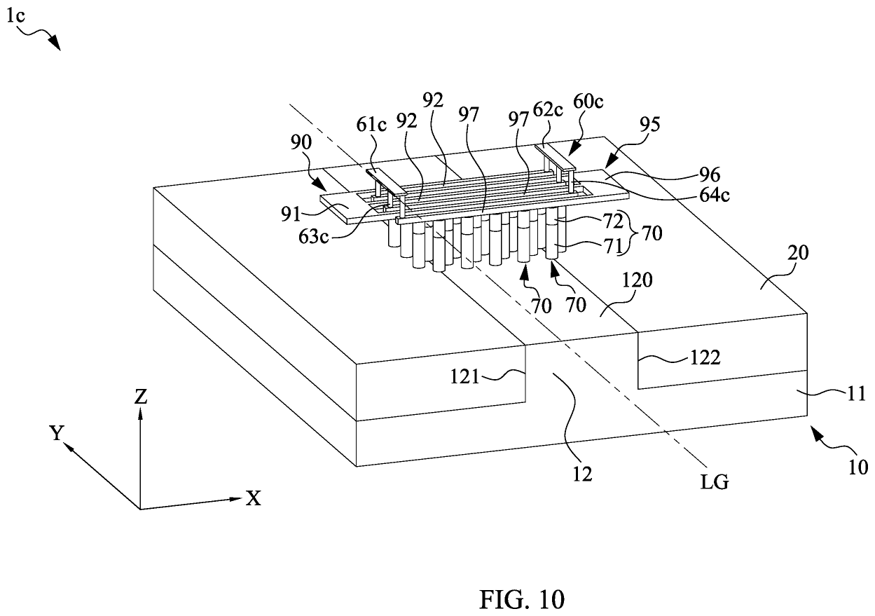

FIG. 10 is a schematic view of an optical device 1c, in accordance with one or more embodiments of the present disclosure. The components in FIG. 10 that use the same reference numerals as the components of FIG. 7A refer to the same components or equivalent components thereof. For the sake of brevity, it will not be repeated here. Differences between the optical device 1c and the optical device 1b include the heating member 50 being replaced with two heating members 90 and 95.

The two heating members 90 and 95 are used to regulate temperature of the light controlling unit 70 in different groups. In some embodiments, the heating member 90 includes a connecting portion 91 and a number of finger portions 92. The finger portions 92 extend from one edge of the connecting portion 91 in a direction that is perpendicular to the longitudinal axis LG of the waveguide 10. Similarly, the heating member 95 includes a connecting portion 96 and a number of finger portions 97. The finger portions 97 extend from one edge of the connecting portion 96 in a direction that is perpendicular to the longitudinal axis LG of the waveguide 10. The heating members 90 and 95 may be placed on the same level, and the finger portions thereof are arranged in a staggered manner. That is, at least one of the finger portions 92 of the heating member 90 are located in a slot formed by two neighboring finger portions 97 of the heating member 95, and at least one of the finger portions 97 of the heating member 95 are located in a slot formed by two neighboring finger portions 92 of the heating member 90.

The heating members 90 and 95 are configured to produce heat in response to the application of electric current provided by the electrical connecting unit 60c. The electrical connecting unit 60 include a first metal pad 61c, a second metal pad 62c, and multiple contacts 63c and 64c. A first set of one or more contacts 63c extends downward from the first metal pad 61c to the finger portions 97 of the heating member 95 to couple the first metal pad 61c to the heating member 95. A second set of one or more contacts 64c extends downward from the second metal pad 62c to the finger portions 92 of the heating member 90 to couple the second metal pad 62c to the heating member 90.

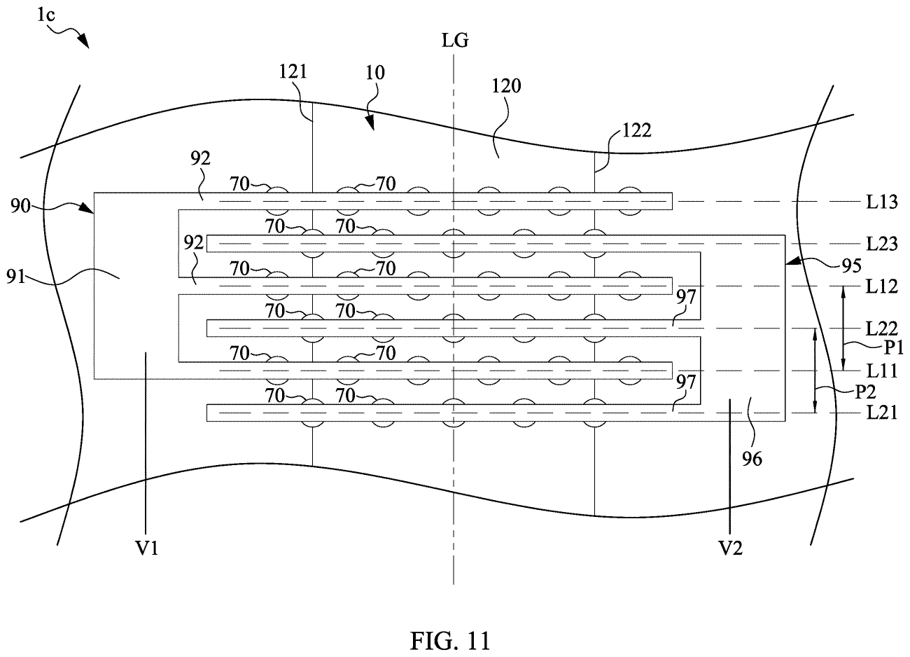

FIG. 11 is a top view of partial elements of the optical device 1c, in accordance with one or more embodiments of the present disclosure. In some embodiments, the finger portions 92 of the heating member 90 are coupled to the first group of the light controlling units 70 arranged along the first reference lines L11, L12 and L13. In addition, the finger portions 97 of the heating member 95 are coupled to the second group of the light controlling units 70 arranged along the second reference lines L21, L22, and L23.

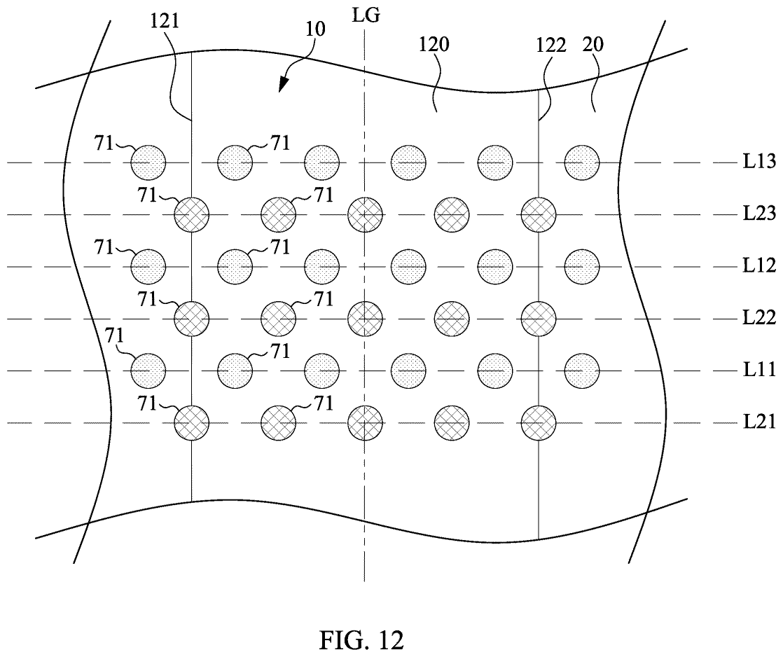

In operation, different power voltages (or electric currents) V1 and V2 are alternately applied to the heating member 90 and the heating member 95, and therefore the finger portions 92 are heated to a different temperature than the finger portions 97. In one exemplary embodiment shown in FIG. 12, a short and high-amplitude electrical pulse V1 is used to melt-quench the light modulators 71 arranged along the first reference lines L11, L12 and L13, which leads a transformation of these light modulators 71 to the amorphous state. At the same time, a longer and lower amplitude electrical pulse V2 is used to anneal the light modulators 71 arranged along the second reference lines L21, L22, and L23, which leads transformation of these light modulators 71 to the crystalline state. As a result, light propagated in the waveguide 10 is regulated by the light modulators 71 arranged along the first reference lines L11, L12 and L13 and is blocked from entering the light modulators 71 arranged along the second reference lines L21, L22, and L23.

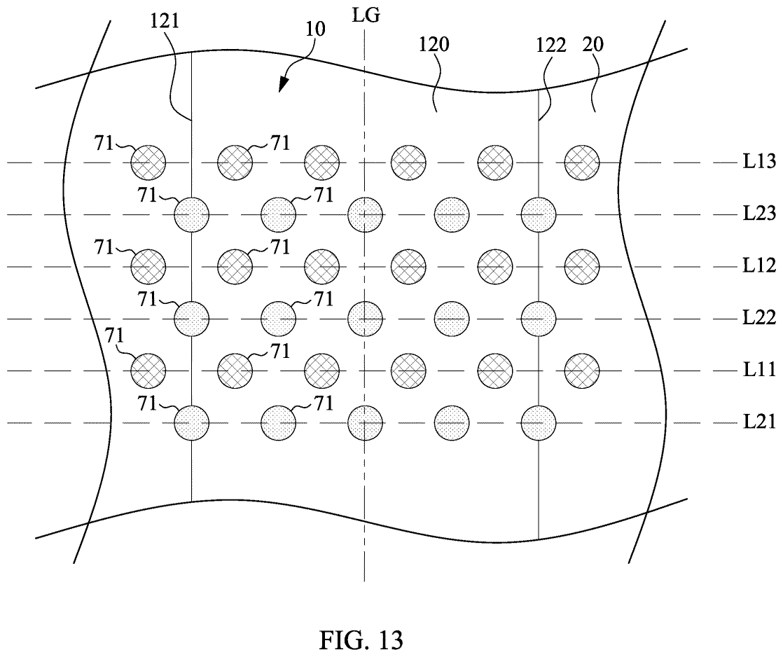

After the operation above is finished, the electrical pulses applied to the heating member 90 and the heating member 95 are exchanged so as to change the structural phase of the light modulators in different groups. Specifically, as shown in FIG. 13, a longer and lower amplitude electrical pulse V2 is used to melt-quench the light modulators 71 arranged along the first reference lines L11, L12 and L13, which leads a transformation of these light modulators 71 to the crystalline state. At the same time, a short and high-amplitude electrical pulse V1 is used to anneal the light modulators 71 arranged along the second reference lines L21, L22, and L23, which leads transformation of these light modulators 71 to the amorphous state. As a result, light propagated in the waveguide 10 is regulated by the light modulators 71 arranged along the first reference lines L21, L22, and L23 and is blocked from entering the light modulators 71 arranged along the second reference lines L11, L12 and L13. Alternating the electrical pulses applied to different groups may permit an accurate control of the optical properties of the light propagated in the waveguide 10.

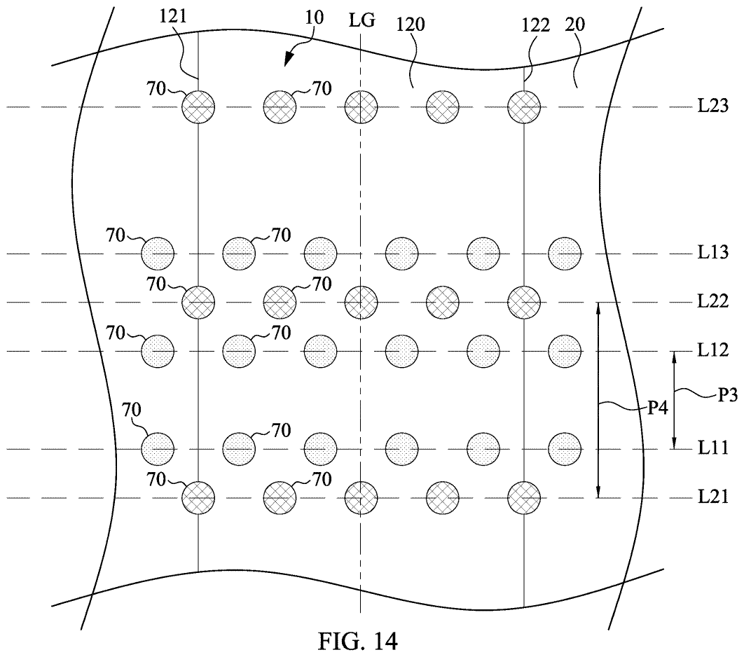

FIG. 14 is a top view of partial elements of an optical device, in accordance with one or more embodiments of the present disclosure. In some embodiments, a number of first reference lines L11, L12 and L13 and a number of second reference lines L21, L22, and L23 are defined on a plane at which the top surface 120 of the waveguide 10 locates and each extends perpendicular to the longitudinal axis LG of the waveguide 10. The first reference lines L11, L12 and L13 are spaced apart from each other by a first pitch P3. The second reference lines are spaced apart from each other by a second pitch P4. In the embodiment shown in FIG. 14, the first pitch P3 is different from the second pitch P4. A first group of the light controlling units 70 are arranged along the first reference lines L11, L12 and L13, and a second group of the light controlling units 70 are arranged along the second reference lines L21, L22, and L23. Due to the different pitches between the light controlling units 70 in different groups, light with different wavelength can be independently controlled.

For example, in order to regulate a light with shorter wavelength, the light controlling units 70 arranged along the first reference lines L11, L12 and L13 are set in the amorphous state, while the light controlling units 70 arranged along the second reference lines L21, L22, and L23 are set in the crystalline state. Therefore, light with the shorter wavelength is modulated by the light controlling units 70 arranged along the first reference lines L11, L12 and L13, but light with longer wavelength will pass through the array of the light controlling units 70 directly and be outputted from the waveguide. In contrast, in order to regulate a light with longer wavelength, the light controlling units 70 arranged along the first reference lines L11, L12 and L13 are set in the crystalline state, while the light controlling units 70 arranged along the second reference lines L21, L22, and L23 are set in the amorphous state. Therefore, light with the longer wavelength is modulated by the light controlling units 70 arranged along the first reference lines L21, L22, and L23, but light with shorter wavelength will pass through the array of light controlling units 70 directly and be outputted from the waveguide.

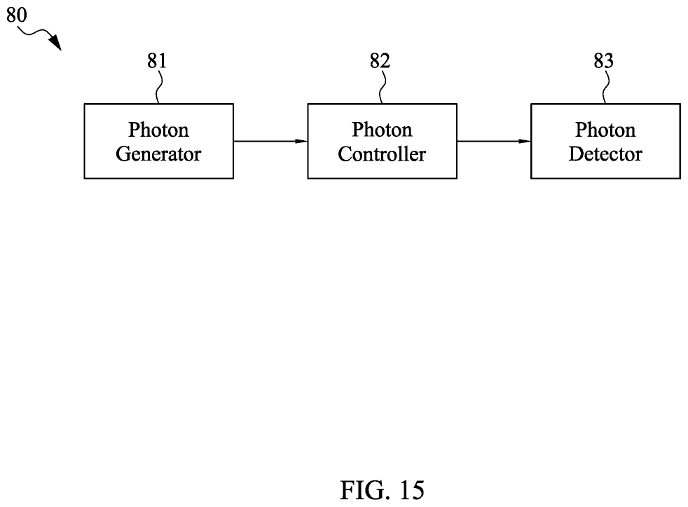

FIG. 15 is a block diagram of a computing system 80, in accordance with one or more embodiments of the present disclosure. The computing system 80 is configured to use light waves for data processing, data storage or data communication for computing. In accordance with some embodiments, the computing system 80 includes one or more photon generators 81, a photon controller 82 and a photon detector 83. The photon generators 81, the photon controller 82 and the photon detector 83 are coupled through optical fibers 84. Optical communication uses optical fibers 84 as a transmission medium. Optical fibers can be either multimode fibers (MMF), which ease light coupling within the fiber but limit the transmission distance, or single-mode fibers (SMF), which allow long-distance transmissions for applications such as telecommunications. Light signal generated from the photon generators 81 is processed by the photon controller 82, and then is sent to the photon detector 83 for analyzing.

The photon generator 81 may be any suitable source of coherent light. In some embodiments, the photon generator 81 may be a diode laser or a vertical-cavity surface emitting lasers (VCSEL). In some embodiments, the photon generator 81 is configured to have an output power greater than 10 mW, greater than 25 mW, greater than 50 mW, or greater than 75 mW. In some embodiments, the photon generator 81 is configured to have an output power less than 100 mW. The photon generator 81 may be configured to emit a continuous wave of light or pulses of light (“optical pulses”) at one or more wavelengths. The temporal duration of the optical pulses may be, for example, about 100 ps. Using multiple wavelengths of light allows some embodiments to be multiplexed such that multiple calculations may be performed simultaneously using the same optical hardware. Some embodiments may use two or more phase-locked light sources of the same wavelength at the same time to increase the optical power entering the optical encoder system.

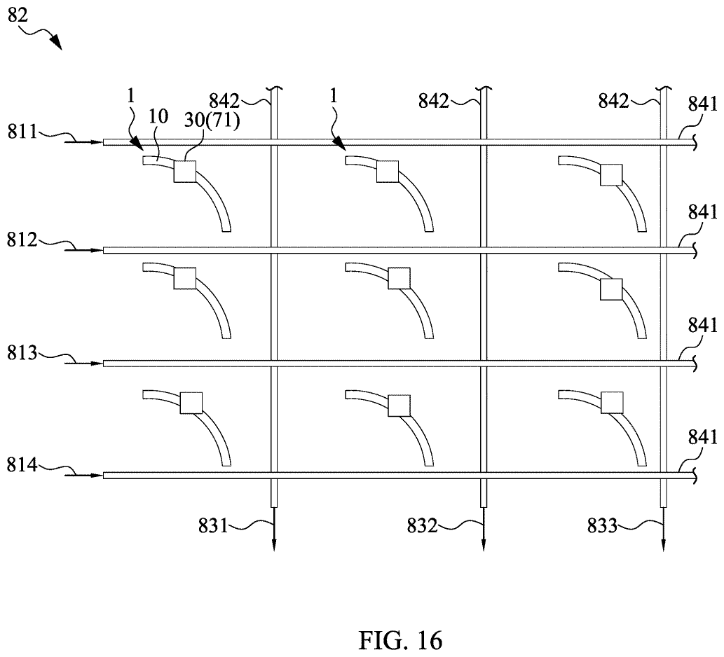

The photon controller 82 is configured to regulate the amplitude or phase of the optical signals generated from the photon generator 81. Exemplary embodiment of the photon controller 82 will be described in detail with reference to FIGS. 16-18 below. The photon detector 83 receives the optical pulses from the photon controller 82. Each of the optical pulses is then converted to electrical signals. In some embodiments, the intensity and phase of each of the optical pulses is measured by optical detectors within the optical receiver. The electrical signals representing those measured values are then output to a processor (not shown in the figures).

FIG. 16 is a schematic view of a photon controller 82, in accordance with one or more embodiments of the present disclosure. In some embodiments, the photon controller 82 includes a number of traversal optical lines 841 and a number of longitudinal optical lines 842. The traversal optical lines 841 and the longitudinal optical lines 842 constitute an integrated 3×3 crossbar array chip. A number of optical devices 1 are positioned adjacent to intersections of the traversal optical lines 841 and the longitudinal optical lines 842. When light signals 811, 812, 813 and 814 enters the traversal optical lines 841, one part of the light is coupled into the waveguide 10 of the optical device 1 and then is coupled into the longitudinal optical lines 842, and the other part of light is output directly through the traversal optical lines 841. The light signals 831, 832 and 833 transmitted in the longitudinal optical lines 842 are then to be outputted from photon controller 82. The different phase states of the light modulators 30 or 71 attached on the waveguides 10 will affect the coupling coefficient in the coupling region of the waveguide 10 and the optical lines. By selecting the appropriate structural parameters of the light modulators 30 or 71, signals propagating in the horizontal direction are selectively coupled and multiplexed in optical lines along the vertical direction.

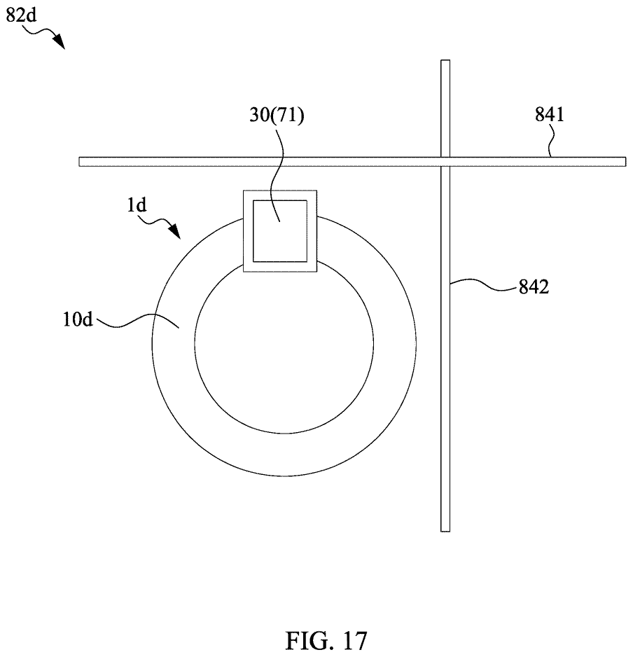

FIG. 17 is a schematic view of partial elements of a photon controller 82d, in accordance with one or more embodiments of the present disclosure. The components in FIG. 17 that use the same reference numerals as the components of FIG. 16 refer to the same components or equivalent components thereof. For the sake of brevity, it will not be repeated here. Differences between the photon controller 82d and the photon controller 82 include the optical device 1 being replaced with optical device 1d. In some embodiments, the optical device 1d is an optical ring resonator and includes a waveguide 10d and a light modulator 30 or 71 attached on the waveguide 10d. The waveguide 10d is a closed loop optical path and is coupled to the traversal optical lines 841 and the longitudinal optical lines 842. When light of the resonant wavelength is passed through the waveguide 10d from the traversal optical lines 841, the light builds up in intensity over multiple round-trips owing to constructive interference and is output to the longitudinal optical lines 842. Because a select few wavelengths will be at resonance within the waveguide 10d, the optical ring resonator may function as a filter.

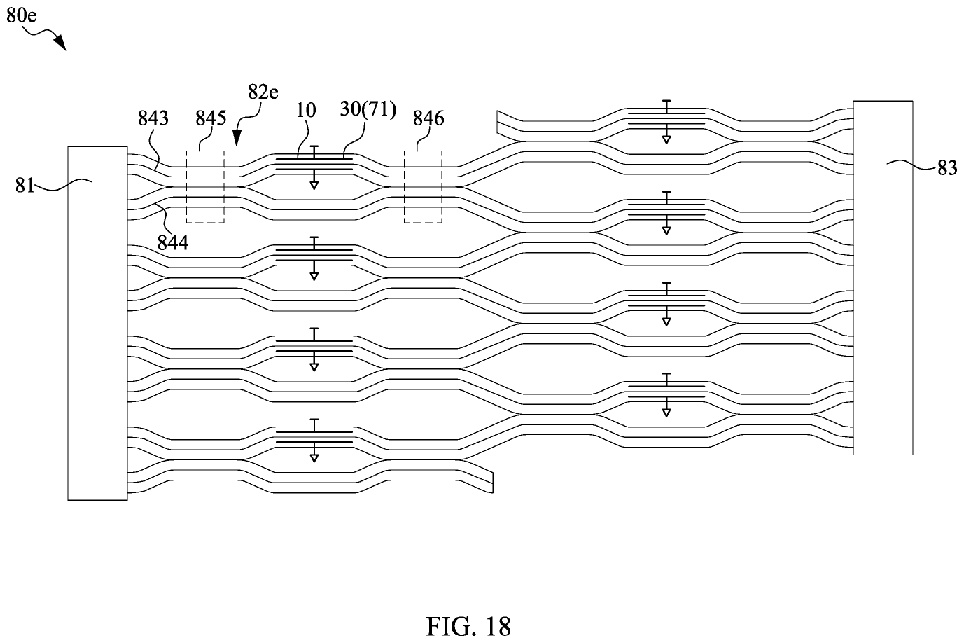

FIG. 18 is a schematic view of a computing system 80e, in accordance with one or more embodiments of the present disclosure. The computing system 80e is configured to use light waves for data processing, data storage or data communication for computing. In accordance with some embodiments, the computing system 80e includes one or more photon generators 81, a photon controller 82e and a photon detector 83. The photon controller 82e includes a number of optical lines, such as optical lines 843 and 844. The waveguide 10 is coupled to the optical line 843 and the light modulator 30 or 71 is attached to the waveguide 10. In some embodiments, the computing system 80e includes a first evanescent coupler 845 and a second evanescent coupler 846 for mixing the two input modes of the photon controller 82e. The light modulator 30 modulates the phase θ in optical line 843 of the photon controller 82 e to create a phase difference between the two optical lines 843 and 844. Adjusting the phase θ causes the intensity of light output by the photon controller 82e to vary from one output mode of the photon controller 82e to the other thereby creating a beam splitter that is controllable and variable.

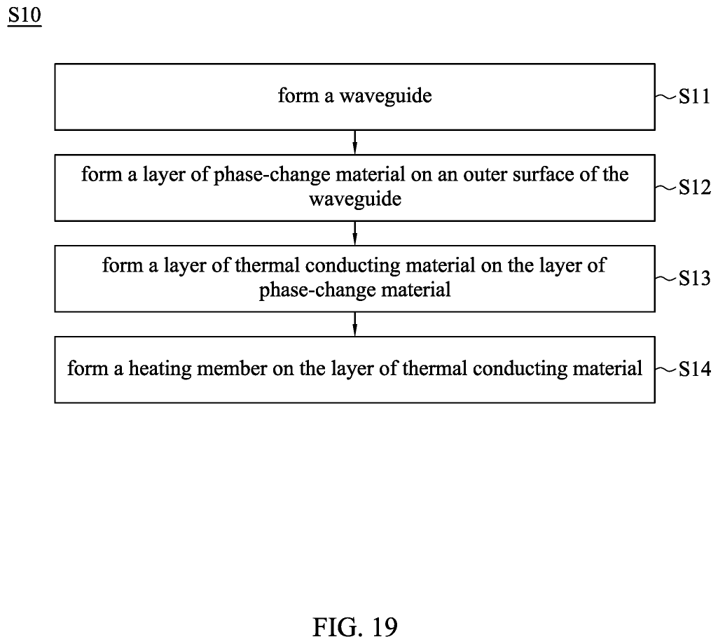

FIG. 19 is a flowchart illustrating a method S10 of fabricating an optical device, in accordance with one or more embodiments of the present disclosure. In some embodiments, the method S10 includes operation S11, in which waveguide, such as waveguide 10 in FIG. 2A, is formed. The method S10 also includes operation S12, in which a layer of phase-change material, such as phase-change material 31 in FIG. 2B, is formed on an outer surface (e.g., top surface 120) of the waveguide 10. The method S10 further includes operation S13, in which a layer of thermal conducting material, such as thermal conducting material 41 in FIG. 2C, is formed on the layer of phase-change material. In addition, the method S10 includes operation S14, in which a heating member, such heating member 50 in FIG. 2E, is formed on the layer of thermal conducting material.

Embodiments of the present disclosure provide an optical device and a method of fabricating the same. The optical device uses a light modulator to modulate the property of light that passes through the waveguide thereof. The light modulator is made of a phase-change material which exhibits different light transmissions in different temperatures. Since the light modulator is separated from a heating member that produce heat in response to electrical pulse, the reliability of the light modular can be improved. In some embodiments of present disclosure, the light modulators are arranged periodically, so that light at frequency corresponding to the pitch of the light modulator can be precisely modulated. The optical devices in different embodiments of present disclosure are applicable to an optical computing system to meet the increasingly developing demands of low power consumption and high performance devices.

One embodiment of the present disclosure provides an optical device which includes a waveguide and a light modulator. The light modulator includes a phase-change material and is in direct contact with an outer surface of the waveguide. The optical device also includes a thermal conducting member. The thermal conducting member is positioned on the light modulating member. The optical device further includes a heating member. The heating member is placed on the thermal conducting member and is distant away from the light modulator and the waveguide. The heat produced from the heating member is transferred to the light modulator through the thermal conducting member thereby inducing a phase transition of the light modulator.

Another embodiment of the present disclosure provides a method of fabricating an optical device. The method includes forming a waveguide and forming a layer of phase-change material on an outer surface of the waveguide. The method also includes forming a layer of thermal conducting material on the layer of phase-change material. The method further includes forming a heating member on the layer of thermal conducting material. The heating member is located higher than the outer surface of the waveguide at which the layer of phase-change material contacts.

Yet another embodiment of the present disclosure provides a computing system. The computing system includes a photon generator configured to produce a light signal. The computing system also include a photon controller which include the optical device mentioned in the embodiment above. The computing system further includes a photon detector configured to receive the light signal from the photon controller.

The foregoing outlines structures of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computing system, comprising:
a photon generator configured to produce a light signal;
a photon controller configured to modulate the light signal from the photon generator and comprising:
a waveguide;
a light modulator comprising a phase-change material and being in direct contact with an outer surface of the waveguide;
a thermal conducting member disposed on the light modulator; and
a heating member disposed on the thermal conducting member, wherein heat produced from the heating member is transferred to the light modulator through the thermal conducting member thereby inducing a phase transition of the light modulator; and
a photon detector configured to receive the light signal from the photon controller.

2. The computing system of claim 1, further comprising a photonic circuit connected between the photon generator and the photon detector, wherein the optical device is positioned adjacent to the photonic circuit with a spacing formed between the waveguide and the phonic circuit.

3. The computing system of claim 2, wherein the waveguide forms a micro ring resonant, and the thermal conducting member and the heating member are disposed on the micro ring resonant.

4. The computing system of claim 1, further comprising two light traveling paths extending from the photon generator to the photon detector, wherein the waveguide forms a segment of one of the two light traveling path.

5. The computing system of claim 1, wherein the photon generator comprises a diode laser or a vertical-cavity surface emitting laser (VCSEL) configured to emit continuous waves or optical pulses, and the photon detector comprises optical detectors configured to measure an intensity and a phase of the light signal and convert the light signal into electrical signals output to a processor.

6. The computing system of claim 1, wherein the thermal conducting member comprises an electrical insulating material selected from the group consisting of silicon nitride, aluminum nitride, diamond, and sapphire.

7. The computing system of claim 1, wherein the phase-change material is configured to be switched between a disordered amorphous state and an ordered crystalline state, wherein the disordered amorphous state and the ordered crystalline state exhibit different refractive indices and extinction coefficients for the light signal travelling in the waveguide.

8. The computing system of claim 1, wherein the heating member comprises:
two electric contact segments positioned at two ends along a longitudinal axis of the heating member; and
an intermediate segment connecting the two electric contact segments and being in contact with the thermal conducting member, wherein a width of the intermediate segment varies in a traverse direction that is perpendicular to the longitudinal axis.

9. The computing system of claim 8, wherein the intermediate segment comprises a middle contacting portion in contact with the thermal conducting member and two intermediate portions respectively connecting ends of the middle contacting portion to the two electric contact segments, wherein a width of the two intermediate portions is greater than a width of the middle contacting portion in the traverse direction.

10. A computing system, comprising:
a photon generator configured to produce a light signal;
a photon controller configured to modulate the light signal from the photon generator, the photon controller comprising:
a waveguide comprising a rib portion with a top surface;
a light modulator comprising a phase-change material and being in direct contact with the top surface of the waveguide;
a thermal conducting member disposed on the light modulator; and
a heating member disposed on the thermal conducting member and being distant away from the light modulator and the waveguide, wherein heat produced from the heating member is transferred to the light modulator through the thermal conducting member thereby inducing a phase transition of the light modulator,
wherein the heating member is located higher than the top surface of the waveguide at which the phase-change material is formed; and
a photon detector configured to receive the light signal from the photon controller.

11. The computing system of claim 10, wherein the thermal conducting member comprises an electrical insulating material selected from the group consisting of silicon nitride, aluminum nitride, diamond, and sapphire.

12. The computing system of claim 10, wherein the phase-change material is configured to be switched between a disordered amorphous state and an ordered crystalline state, wherein the disordered amorphous state and the ordered crystalline state exhibit different refractive indices and extinction coefficients for the light signal travelling in the waveguide.

13. The computing system of claim 10, wherein the heating member comprises:
two electric contact segments positioned at two ends along a longitudinal axis of the heating member; and
an intermediate segment connecting the two electric contact segments and being in contact with the thermal conducting member, wherein a width of the intermediate segment varies in a traverse direction that is perpendicular to the longitudinal axis.

14. The computing system of claim 13, wherein the intermediate segment comprises a middle contacting portion in contact with the thermal conducting member and two intermediate portions respectively connecting ends of the middle contacting portion to the two electric contact segments, wherein a width of the two intermediate portions is greater than a width of the middle contacting portion in the traverse direction.

15. A computing system, comprising:
a photon generator configured to produce a light signal;
a photon controller configured to modulate the light signal from the photon generator, the photon controller comprising:
a waveguide;
a plurality of discrete light controlling units independently distributed and spaced apart from each other on an outer surface of the waveguide, wherein each of the plurality of discrete light controlling units comprises a light modulator comprising a phase-change material in direct contact with the outer surface of the waveguide and a thermal conducting member formed atop the light modulator; and
a heating member disposed on the thermal conducting member of each of the plurality of discrete light controlling units and positioned distant from the light modulators and the waveguide, wherein heat produced from the heating member is transferred to the light modulators through the respective thermal conducting members thereby inducing a phase transition of the light modulators; and
a photon detector configured to receive the light signal from the photon controller.

16. The computing system of claim 15, wherein the thermal conducting member of each of the plurality of discrete light controlling units comprises an electrical insulating material selected from the group consisting of silicon nitride, aluminum nitride, diamond, and sapphire.

17. The computing system of claim 15, wherein the phase-change material of each of the plurality of discrete light controlling units is configured to be switched between a disordered amorphous state and an ordered crystalline state to selectively modulate properties of the light signal.

18. The computing system of claim 15, wherein the heating member comprises:
two electric contact segments positioned at two ends along a longitudinal axis (LH) of the heating member; and
an intermediate segment connecting the two electric contact segments and being in contact with the thermal conducting members, wherein a width of the intermediate segment varies in a traverse direction that is perpendicular to the longitudinal axis (LH).

19. The computing system of claim 18, wherein the intermediate segment comprises a middle contacting portion in contact with the thermal conducting member and two intermediate portions respectively connecting ends of the middle contacting portion to the two electric contact segments, wherein a width of the two intermediate portions is greater than a width of the middle contacting portion in the traverse direction.

20. The computing system of claim 15, wherein each of the plurality of discrete light controlling units has a circular, square, or hexagonal cross-section, and the plurality of discrete light controlling units are arranged on the waveguide periodically along a direction parallel to a longitudinal axis of the waveguide.
